(19) United States
(12) Patent Application Publication
(10) Pub. No.: US 2018/0104617 A1
(43) Pub. Date: Apr. 19, 2018

(54) SEMICONTINUOUS DIVIDED WALL DISTILLATION

(71) Applicant: McMaster University, Hamilton (CA)

(72) Inventors: Thomas A. Adams, II, Dundas (CA); Sarah Ballinger, Toronto (CA)

(21) Appl. No.: 15/784,994

(22) Filed: Oct. 16, 2017

Related U.S. Application Data
(60) Provisional application No. 62/408,369, filed on Oct. 14, 2016.

(51) Int. Cl. B01D 3/14; B01D 3/42; B01D 3/32

(52) U.S. Cl. CPC B01D 3/141; B01D 3/324; B01D 3/4261

(57) ABSTRACT

A distillation column for separating components of a feed stream is described herein. The distillation column has a top end; a bottom end spaced from the top end; a set of trays dispersed along a length of the distillation column between the top end and the bottom end; and a dividing wall extending between the top end and the bottom end to divide the distillation column into a pre-fractionation zone, a top zone, a bottom zone and an outflow zone. The feed stream includes a most volatile component, a first intermediate volatile component, a second intermediate volatile component and a least volatile component.

### CROSS-REFERENCE TO RELATED APPLICATION

This application claims priority to U.S. Provisional Application No. 62/408,369 filed on Oct. 14, 2016, the entire contents of which are hereby incorporated herein by reference.

### TECHNICAL FIELD

The embodiments disclosed herein relate to separation of components by distillation, and, in particular to systems and apparatus and methods for semicontinuous dividing wall column distillation.

### BACKGROUND

Process intensification is any improvement to chemical plants that drastically reduces the size, energy usage and waste production. Distillation is an energy intensive separation process and process intensification improvements result in the development of systems with substantial energy savings and cost reduction. Dividing wall columns (DWC) are distillation units with a single shell and a sheet partitioning the middle section of trays such that a three-component mixture can be purified using one column.

Semicontinuous distillation uses a single column to separate any number of components, replacing the deleted columns with simple tanks. Previous systems have demonstrated distillation processes that purify four or five components with one column and two or three middle vessel tanks. Further, generalized semicontinuous distillation to separate any number of components using one column and two less middle vessel tanks than components has been described. As a result, there are many different applications for semicontinuous distillation.

One advantage to operating a distillation column in a semicontinuous manner is economic benefit. The capital investment required for a semi-continuously operated distillation column is greatly lower than the capital investment required for a continuously operated distillation column sequence, which requires multiple distillation columns working in series. The energy costs of a semi-continuously operated distillation column system are much lower than an equivalent batch distillation system because the batch system requires inefficient cool-down and start-up steps as a part of its operational cycle, whereas the semicontinuous system does not. As a result, semicontinuous distillation is a cheaper process than both batch and continuous distillation for intermediate production rates.

Semicontinuous distillation without a middle vessel (SwoMV) has previously been developed to increase the throughput of processes and to decrease the overall cost of traditional semicontinuous distillation. There are a few defining differences between the SwoMV and conventional semicontinuous distillation processes. For example, a SwoMV column is fed with fresh feed continuously (although at variable flow rates) and the destination of the side stream changes throughout each cycle.

The dividing wall column (DWC) is another process intensification separation technology that operates more economically and energy favorably than continuous distillation systems. For instance, the DWC can be run continuously to separate a three-component mixture in a single shell with a sheet partitioning the middle section of trays. In this configuration, an intermediate component accumulates on the right side of the wall and is directly withdrawn in a side draw stream. The most and least volatile components are withdrawn as the distillate and bottoms streams, respectively. Since there is only one column and two heat exchangers to separate three components, this configuration not only has a lower capital cost, but also is more energetically favorable than continuous distillation. For certain situations, continuous DWC are cheaper than conventional continuous distillation.

Accordingly, there is a need for a semicontinuous divided wall distillation column and methods of separating components using a semicontinuous divided wall distillation column.

### SUMMARY

In one aspect, a distillation column for separating components of a feed stream is provided. The feed stream includes a most volatile component, a first intermediate volatile component, a second intermediate volatile component and a least volatile component. The distillation column includes a top end, a bottom end spaced from the top end, a set of trays dispersed along a length of the distillation column between the top end and the bottom end, and a dividing wall extending between the top end and the bottom end to divide the distillation column into a pre-fractionation zone, a top zone, a bottom zone and an outflow zone. The feed stream flows into the pre-fractionation zone, a distillate product stream comprising the most volatile component flows out of the top zone, a bottoms product stream comprising the least volatile component flows out of the bottom zone, and a first intermediate stream comprising the first intermediate volatile component and a second intermediate stream comprising the second intermediate volatile component flow out of the outlet zone. At least a portion of the second intermediate stream flows into the distillation column as a recycle when a concentration of the second intermediate volatile component in the second intermediate stream falls below a lower bound.

In some other embodiments, the set of trays has 28 trays and the dividing wall divides 20 of the trays.

In some other embodiments, the dividing wall divides 20 middle trays of the column.

In some other embodiments, the dividing wall divides each of the 20 middle trays so that the pre-fractionation zone occupies 20% of a surface area of each of the 20 middle trays.

In some other embodiments, a top 15 trays of the set of trays are spaced 18 inches apart from each other and a bottom 13 trays of the set of trays are spaced 12 inches apart from each other.

In some other embodiments, the dividing wall has a top edge and a bottom edge and the pre-fractionation zone extends between the top edge and the bottom edge of the dividing wall.

In some other embodiments, the most volatile component is carbon dioxide, the least volatile component is water, the first intermediate volatile component is dimethyl ether and the second intermediate volatile component is methanol.

In some other embodiments, the first intermediate stream flows out of tray 8 of the distillation column.

In some other embodiments, the second intermediate stream flows out of tray 14 of the distillation column.

In some other embodiments, the at least a portion of the second intermediate stream is recycled into tray 26 of the distillation column.

In another aspect, a method of separating components of a feed stream in a distillation column is provided. The components include a most volatile component, a first intermediate volatile component, a second intermediate volatile component and a least volatile component. The distillation column has a top end, a bottom end, a set of trays and a dividing wall extending between the top end and the bottom end within the distillation column. The method includes providing the feed stream to a pre-fractionation zone of the distillation column, withdrawing a distillate stream comprising the most volatile component from a top zone of the distillation column, withdrawing a bottoms stream comprising the least volatile component from a bottom zone of the distillation column, withdrawing a first intermediate stream comprising the first intermediate volatile component and a second intermediate stream comprising the second intermediate volatile component from an outflow zone of the distillation column, monitoring a concentration of the second intermediate volatile component in the second intermediate stream withdrawn from the outflow zone of the distillation column, and directing at least a portion of the second intermediate stream to the distillation column when a concentration of the second intermediate volatile component in the second intermediate stream falls below a lower bound.

In some other embodiments, the method also includes stopping the directing of at least a portion of the second intermediate stream to the bottom zone of the distillation column when the concentration of the second intermediate volatile component in the second intermediate stream reaches an upper bound.

In some other embodiments, the most volatile component is carbon dioxide, the least volatile component is water, the first intermediate volatile component is dimethyl ether and the second intermediate volatile component is methanol.

In some other embodiments, the distillate stream and the bottoms stream are continuously withdrawn from the distillation column.

In some other embodiments, the withdrawing of the dimethyl ether from the outflow zone of the distillation column is from tray 8 of the distillation column.

In some other embodiments, the withdrawing of the methanol from the outflow zone of the distillation column is from tray 14 of the distillation column.

In some other embodiments, the directing at least a portion of the second intermediate stream to the distillation column is into tray 26 of the distillation column.

In some other embodiments, the feed stream is continuously provided to tray 17 of the distillation column.

In some other embodiments, the lower bound is about 98.7 mol %.

In some other embodiments, the upper bound is about 99.2 mol %.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

The drawings included herewith are for illustrating various examples of articles, methods, and apparatuses of the present specification. In the drawings:

FIG. 1 is a schematic view of an exemplary distillation column having a pre-fractionation zone (I), an outflow zone (II), a top zone (III) and a bottom zone (IV);

FIG. 2 is a schematic view of a distillation column for separating components of a feed stream, according to one embodiment;

FIG. 3 is another schematic view of a distillation column for separating components of a feed stream, according to another embodiment;

FIG. 4 is a block diagram showing a method of separating components of a feed stream in a distillation column, according to one embodiment;

FIG. 5 is a graph showing purities of outlet streams from the distillation column of FIG. 3 showing the first 23 cycles of a 50 cycle run, where the call-out portion of the graph shows three chosen cycles in a more detailed view;

FIG. 6 is a graph showing flow rates of the outlet streams from the semicontinuous dividing wall column of FIG. 3;

FIG. 7 is a graph showing absolute energy usage by the condenser and reboiler of the semicontinuous dividing wall column of FIG. 3;

FIG. 8 is a graph showing reflux ratio and boilup ratio of the semicontinuous dividing wall column of FIG. 3;

FIG. 9 is a graph showing a flooding approach profile for Section I of the semicontinuous dividing wall column of FIG. 3;

FIG. 10 is a graph showing a flooding approach profile for Sections II, III and IV of the semicontinuous dividing wall column of FIG. 3; and

FIG. 11 is a graph showing vapour and weeping velocities for the lowest vapour velocities and the most conservative minimum weeping velocity of the semicontinuous dividing wall column of FIG. 3.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “and/or” as used herein means that the listed items are present, or used, individually or in combination. In effect, this term means that “at least one of” or “one or more” of the listed items is used or present.

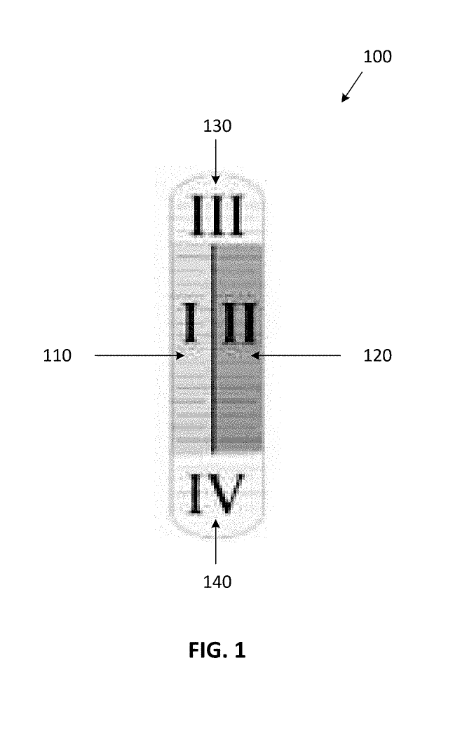

Referring to FIG. 1, illustrated therein is an example of a distillation column 100 having four zones: a pre-fractionation zone (I) 101, an outlet zone (II) 102, a top zone (III) 103 and a bottoms zone (IV) 104.

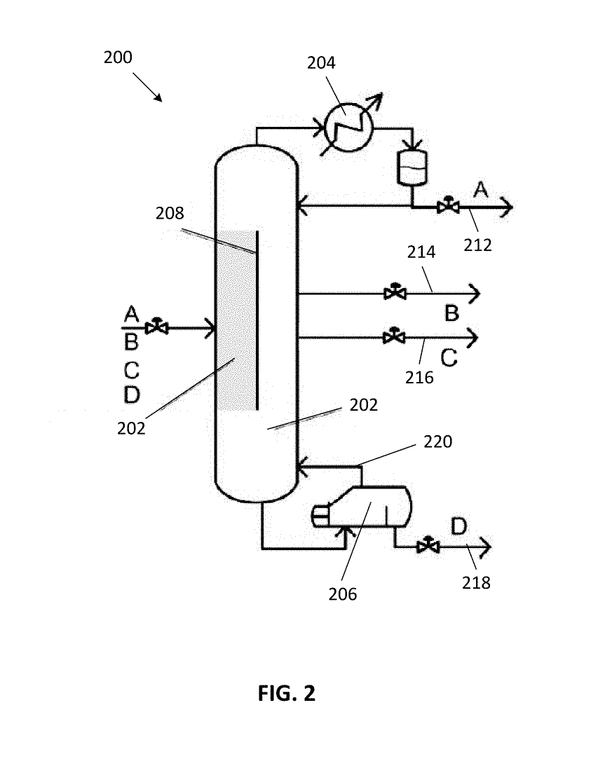

Referring now to FIG. 2, illustrated therein is a distillation column 200 for separating components A, B, C, D of a feed stream. It should be noted that the feed stream can be a liquid, a gas or a combination of the two. In this embodiment, distillation column 200 comprises a pre-fractionation zone 202, a condenser 204, a reboiler 206 and a dividing wall (i.e. partition) 208. In this embodiment, components A, B, C and D represent components having various volatilities. For example, component A may be a most volatile component and be separated in a distillate (e.g. top) stream 212 flowing out of a top portion of the distillation column 200, component B may be a first intermediate volatile component and be separated in a first intermediate stream 214 flowing out of an outflow portion of the distillation column 200, component C may be a second intermediate volatile component and be separated in a second intermediate stream 216 flowing out of the outflow portion of the distillation column 200, and component D may be a most volatile component and be separated in a bottoms stream 218 flowing out of a bottoms portion of the distillation column 200.

In one embodiment, at least a portion of bottoms stream 218 can be directed to (e.g. returned to) column 202 as a recycle. For example, at least a portion of bottoms stream 218 can be directed to (e.g. returned to) column 202 as a recycle when a concentration of most volatile component D in the bottoms stream 218 reaches a lower bound (e.g. a set minimum desired concentration of most volatile component D in the bottoms stream 218).

In another embodiment, the at least a portion of bottoms stream 218 that is directed to (e.g. returned to) column 202 as a recycle when a concentration of most volatile component D in the bottoms stream 218 reaches a lower bound can be stopped when the at least a portion of bottoms stream 218 that is directed to (e.g. returned to) column 202 as a recycle has a concentration of most volatile component D in the bottoms stream 218 that exceeds a higher bound (e.g. a set maximum desired concentration of the most volatile component D in the bottoms stream 218).

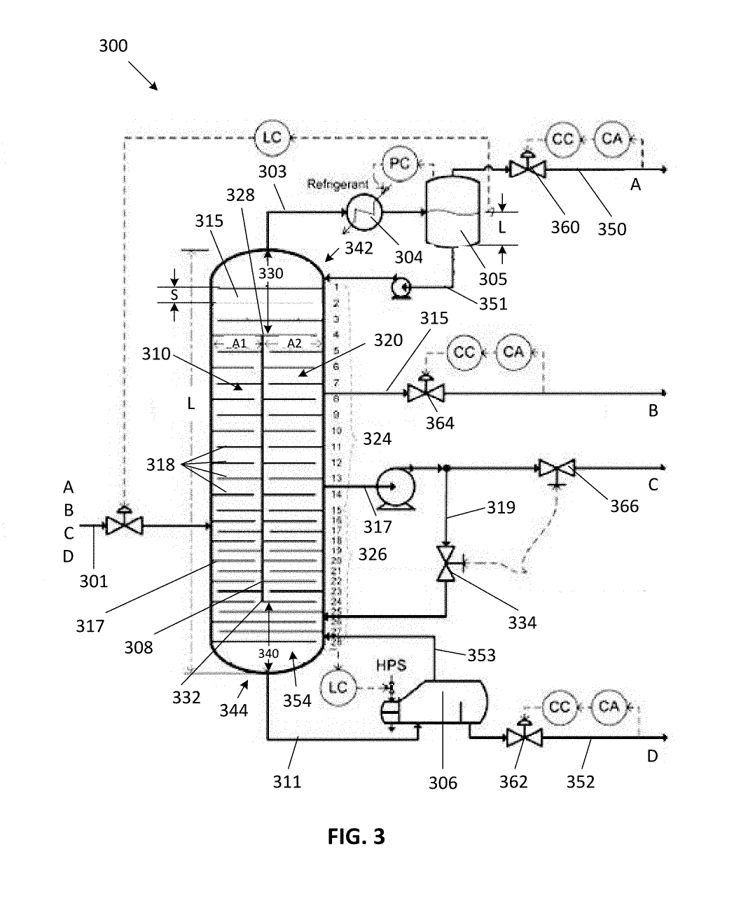

Referring now to FIG. 3, illustrated therein is a distillation column 300 for separating components of a feed stream 301. The distillation column 300 is a dividing wall column that may be operated in a semicontinuous manner and therefore may be referred to as a semicontinuous dividing wall column (“S-DWC”). In the embodiment shown in FIG. 3, distillation column 300 separates a four-component mixture using a single main column 302.

The column 302 has a condenser 304, a reflux drum 305, a reboiler 306, dividing wall 308 and a set of trays 315 disposed in inside of column 302. Column 302 can be divided into four sections corresponding to the sections shown in the column 100 of FIG.1. For example, a section shown to the left of the divided wall 308 in FIG. 3 is can be referred to as a pre-fractionation section 310, a section to the right of the divided wall 308 can be referred to as an outflow section 320, a section above the dividing wall 308 can be referred to as a top (or distillate) section 330 and a section below the dividing wall 308 can be referred to as a bottom (or bottoms) section 340. The column 302 has a top end 342 and a bottom end 344.

In the embodiment shown in FIG. 3, column 302 has a set of trays 315 disposed (e.g. dispersed) along a length L of the column 302. Set of trays 315 much can include as many trays 315 as can be supported without the column 302 falling over or violating local height restrictions, for example. Each tray 318 of the set of trays 315 is horizontally oriented within column 302 and extends from either a sidewall 317 of the column towards the dividing wall 308 or from the dividing wall 308 towards a sidewall of the column. Each tray 318 of the set of trays 315 is spaced from an adjacent tray 318 by a spacing S (as shown in FIG. 3). Spacing S can be consistent between each of the trays 318 of the set of trays 315 or spacing S can vary between each tray 318 of the set of trays 315. Also, groups of trays within the set of trays 315 can have a same spacing S.

In the embodiment shown in FIG. 3, the set of trays 315 includes 28 trays. Of the 28 trays, the uppermost trays 324 have a spacing of 18 inches (e.g. each tray 318 of the uppermost trays 324 is spaced 18 inches apart from an adjacent tray) and the lowermost trays 326 have a spacing of 12 inches (e.g. each tray 318 of the lowermost trays 326 is spaced 12 inches apart from an adjacent tray). In the embodiment shown on FIG. 3, each tray 318 is numbered sequentially from top zone 330 of column 302 to bottom zone 340 of column 302.

Column 302 generally has a width W that is smaller than length L. In the embodiment shown in FIG. 3, column 302 has a width W (e.g. diameter) of three feet.

The column 302 has a dividing wall 308 disposed therein. Dividing wall 308 extends vertically between top zone 330 and bottom zone 340 of column 302 transverse to at least one tray 318. Dividing wall 308 can separate a single tray 318 in column 302 or more than one tray 318 in column 302 into a pre-fractionation zone 310 and an outflow zone 320. Dividing wall 308 is generally positioned to oppose feed stream 301 such that liquid and/or gas entering column 302 via feed stream 301 enters into pre-fractionation zone 310 and is opposed by dividing wall 308. Generally, the liquid and/or gas from feed stream 301 is directed upwards towards top zone 330 or downwards towards bottom zone 340 upon entering column 302. In this manner, at least a portion of dividing wall 308 separates a tray upon which feed stream 301 enters column 302. Further, dividing wall 308 may generally separate any of the trays 318. For instance, the dividing wall 308 may separate a middle group of the trays 318 such that an equal number of the trays 318 are positioned above a top edge 328 of the dividing wall 318 and a bottom edge 332 of the dividing wall 318. Alternatively, dividing wall 308 may separate a group of the trays 318 such that a different number of the trays 318 are positioned above top edge 328 of the dividing wall 318 and bottom edge 332 of the dividing wall 318. In the embodiment shown in FIG. 3, the dividing wall 308 separates the middle 20 trays (e.g. four trays 318 are positioned above a top edge 328 of the dividing wall 308 and four trays 318 are positioned below a bottom edge 332 of the dividing wall 308).

Dividing wall 308 can be positioned within column 302 to separate (e.g. divide) each tray 318 into two equal sized portions A1, A2. Dividing wall 308 can also be positioned within column 302 to separate (e.g. divide) each tray 318 into two unequal sized portions A1, A2. For example, dividing wall may be positioned within column 302 to separate each tray 318 into a pre-fractionation portion A1 and an outflow portion A2, where the pre-fractionation portion A1 has an active tray area that is in a range from about 10-90% of the total active tray area of each plate 318 and the outflow portion A2 has a corresponding active tray area that is in a range from about 10-90% of the active tray area of each plate 318. A ratio of the area of A1 to A2 can depend on many factors including but not limited to the components in feed stream 301 and height restrictions on column 302. In the embodiment shown in FIG. 3, dividing wall 308 is positioned in column 302 to separate each tray 318 into a pre-fractionation portion A1 and an outflow portion A2, where the pre-fractionation portion A1 has an active tray area that is about 20% of the total area of each plate 318. Accordingly, the outflow portion A2 has an active tray area that is about 80% of the total active tray area of each plate 318. Herein, “active tray” area refers to the portion of the trays with the holes in them (i.e. the useful part for separation) and not the portion of the trays that is structural (i.e. liquid receivers or downcomers).

Feed stream 301 is provided to column 302 and includes four components A, B, C and D. Each of the four components has a different volatility than the other three components. For instance, component A can be a most volatile component, component B can be a first intermediate volatile component (i.e a second-most volatile component), component C can be a second intermediate volatile component (i.e a third-most volatile component) and component D can be a least volatile component. Feed stream 301 can be a liquid, a gas or a combination of the two. Feed stream 301 is provided to the pre-fractionation section 310 of the column 302 continuously throughout operation. In some embodiments, a flow rate of feed stream 301 can vary over time.

Most volatile component A is withdrawn from column 302 in vapour overhead stream 303. After being withdrawn from column 302, vapour overhead stream 303 passes through condenser 304 and is separated in reflux drum 305 into a distillate product stream 350 and a distillate recycle stream 351. In some embodiments, the flow rates of distillate product stream 350 and distillate recycle stream 351 may change over time. For example, in one embodiment, decreasing the flow rate of distillate product stream 350 may increase a concentration of most volatile component A in the distillate product stream 350. In some embodiments, the flow rates of distillate product stream 350 and distillate recycle stream 351 may change cyclically (i.e. at regular intervals) over time. Valve 360 provides for controlling a flow rate of distillate product stream 350.

In the embodiment shown in FIG. 3, distillate product stream 350 is a vapor. This is common when the least volatile component A is a normal gas. However, when least volatile component A is a normal liquid, the condenser 304 may be a total condenser, such that there is no normal vapor product stream exiting flash drum 305 (e.g. the vapor port is used only for pressure management). Instead, the distillate product is collected by taking a percentage of the liquid reflux (e.g. stream 351 of FIG. 3). Example commercial chemical systems that may use this approach include but are not limited to the following:

Benzene, toluene, ethylbeneze, xylene

Hexane, heptane, oxtane, nonane

Methanol, ethanol, propanol, butanol

Ethyl lactate, lactic acid, ethanol, water

Least volatile component D is withdrawn from column 302 continuously in sump liquid product stream 311. After being withdrawn from column 302, sump liquid product stream 311 passes through a reboiler 306 to be separated into a bottoms product stream 352 and a bottoms recycle stream 353. In some embodiments, the flow rates of bottoms product stream 352 and bottoms recycle stream 353 (also known as a boilup stream, reboil stream, or reboiler vapor overhead stream) may change over time. For example, in one embodiment, decreasing a flow rate of bottoms product stream 352 may increase a concentration of least volatile component D in bottoms product stream 352. In other embodiments, the flow rates of bottoms product stream 352 and bottoms recycle stream 353 may change cyclically (i.e. at regular intervals) over time. Valve 362 provides for controlling a flow rate of bottoms product stream 352.

The first intermediate component B (i.e. the second most volatile component) is withdrawn from a tray 318 within the outflow section 320 of column 302 as a first intermediate stream 315. In some embodiments, the first intermediate component B is continuously withdrawn from a tray 318 within the outflow section 320 of column 302 as a first intermediate stream 315. In some embodiments, the flow rate of first intermediate stream 315 changes over time. In some embodiments, the flow rate of first intermediate stream 315 changes cyclically over time. Valve 364 provides for controlling a flow rate of first intermediate stream 315. Typically, the flow rate of the first intermediate stream 315 is less than the liquid flow rate on the corresponding tray 318, such that not all of the liquid on the tray 318 is withdrawn through stream 315. In the embodiment shown in FIG. 3, first intermediate stream 315 is withdrawn from tray 8 (i.e. the 8^{th} tray from the top of the column) and the flow rate of first intermediate stream 315 is less than a flow rate of the liquid on tray 8 such that not all of the liquid on tray 8 is withdrawn through first intermediate stream 315. It should be noted that a control system (not shown) may be able to control flow through first intermediate stream 315 using valve 364.

The second intermediate component C (i.e. the third most volatile component) is withdrawn from a tray 318 within the outflow section 320 of column 302 as a second intermediate stream 317. Further, second intermediate stream 317 is withdrawn from a tray 318 positioned below (e.g. closer to bottoms section 340) a tray 318 from which first intermediate stream 315 is withdrawn from column 302. In some embodiments, the second intermediate component C is continuously withdrawn from a tray 318 within the outflow section 320 of column 302 as a second intermediate stream 317. In some embodiments, the flow rate of second intermediate stream 317 changes over time. In some embodiments, the flow rate of first intermediate stream 317 changes cyclically over time. Valves 334 and 366 together provide for controlling a flow rate of second intermediate stream 317. Typically, the flow rate of the second intermediate stream 317 is less than the liquid flow rate on the corresponding tray 318, such that not all of the liquid on the tray is withdrawn through stream 317. In the embodiment shown in FIG. 3, the second intermediate stream 317 is withdrawn from tray 14 (i.e. the 14^{th} tray from the top of the column) and the flow rate of second intermediate stream 317 is less than a flow rate of the liquid on tray 14 such that not all of the liquid on tray 14 is withdrawn through second intermediate stream 317. In some embodiments, maintaining the flow rate of second intermediate stream 317 below the flow rate of liquid on the tray from which second intermediate stream 317 is withdrawn provides for returning at least a portion of second intermediate stream 317 at various locations (e.g. to various different trays) of column 302 without causing column 302 to fail. It should be noted that a control system (not shown) may be able to control flow through second intermediate stream 317 using valve 366.

Second intermediate stream 317 can be withdrawn from a tray 318 positioned above (e.g. closer to top section 330) a tray 318 upon which feed stream 301 is provided, below a tray 318 upon which feed stream 301 is provided, or at the same tray 318 upon which feed stream 301 is provided.

Withdrawal of second intermediate stream 317 from column 302 can be based on a monitoring of a concentration of second intermediate volatile component C in second intermediate stream 317. For example, a controller (not shown) can monitor a concentration of second intermediate volatile component C in second intermediate stream 317. When the concentration of the second intermediate volatile component C in the second intermediate stream 317 falls below a lower bound, at least a portion of the second intermediate stream 317 can be returned to the column 302 as a recycle stream 319. Recycle stream 319 can be returned to the column 302 at any tray 318 of column 302. For instance, in one embodiment, recycle stream 319 can be returned to column 302 at a tray 318 positioned below the dividing wall (e.g. a tray of the bottoms section 340 of the column 302). In the embodiment shown in FIG. 3, recycle stream 319 is returned to column 302 at tray 26 (i.e. the 26^{th} tray from the top of the column).

While at least a portion of the second intermediate stream 317 is returned to the column 302 as a recycle stream 319, the concentration of the second intermediate volatile component C in the second intermediate stream 317 increases. Once the concentration of the second intermediate volatile component C in the second intermediate stream 317 reaches an upper bound, recycle stream 319 can be reduced (e.g. stopped) and second intermediate stream 317 can be entirely withdrawn from the column 302. Recycle valve 334 can control the flow rate of recycle stream 334. In this manner, withdrawal of the second intermediate stream 317 from column 302 can be said to be semicontinuous.

It should be noted that concentrations of components A, D and C in the distillate, bottoms and first intermediate streams 350, 352, 315, respectively, can each be controlled by manipulating their individual flow rates.

Further, a pressure P in the reflux drum 304 and a sump level 354 of the column 302 can be controlled by duties of the condenser 304 and reboiler 306, respectively. Further still, the flow rate of feed stream 301 to the column 302 can be manipulated to control a level L of liquid in the reflux drum 305.

In one specific embodiment, the column 302 operates with feed stream 301 fed continuously to tray 17 (i.e. the 17^{th} tray from the top of the column) within the pre-fractionation section 310. In this embodiment, carbon dioxide is the most volatile component A, dimethyl ether as the first intermediate volatile component B, methanol is the second intermediate volatile component C and water is the least volatile component D. Carbon dioxide and water are drawn continuously from the distillate 350 and bottoms 352 streams, respectively. Dimethyl ether is withdrawn continuously as first intermediate stream 315 from tray 8 in the outflow section 320 of column 302. Methanol is withdrawn as second intermediate stream 317 from tray 14 (i.e. the 14^{th} tray from the top of the column) in the outflow section 320. The concentration of methanol in the second intermediate stream 317 is initially below the lower bound and is recycled back to tray 26 (i.e. the 26^{th} tray from the top of the column) in the bottoms section 340 of the column 302. After a period of time, the concentration of methanol in the second intermediate stream 317 exceeds an upper bound. When the concentration of methanol in the second intermediate stream 317 exceeds the upper bound, the methanol is withdrawn from the column 302 and the recycle stream is stopped.

The upper and lower bounds are typically set at X+Y % and X−Y %, where X is the average purity desired in second intermediate stream 317, and Y is a range within which the purity can cycle. X and Y are typically design decisions that are case dependent and depend on factors such as but not limited to the component of second intermediate stream 317, design, objectives, etc. In one example, the lower bound of second intermediate stream 317 can be about 98.7 mol % and the upper bound of second intermediate stream 317 can be about 99.2 mol %.

Referring to system 300 generally, system 300 may generally be used for any feed consisting of a zeotropic mixture of at least four chemicals (i.e. components). If there are more than four chemicals in the feed, system 300 may be used to separate the chemicals into four product mixture purities. For example, if there are five chemicals Aᵢ, Bᵢ, Cᵢ, Dᵢ, and Eᵢ in the feed, system 300 may be used to separate Aᵢ into the distillate stream, Bᵢ into a first side draw stream, a mixture of Cᵢ and Dᵢ into a second side draw stream, and Eᵢ into the bottom stream. Other permutations may also be possible.

Also, the volatilities of the chemicals in the feed stream may impact the number of trays in column 302 and/or the number of trays between the withdraw streams (e.g. the distillate stream, the side stream(s) and the bottoms stream). For example, as the volatilities of components A (e.g. a most volatile component) and B (a first intermediate volatile component) become more similar, the number of trays below the top of the column and above the first intermediate stream increase to achieve separation.

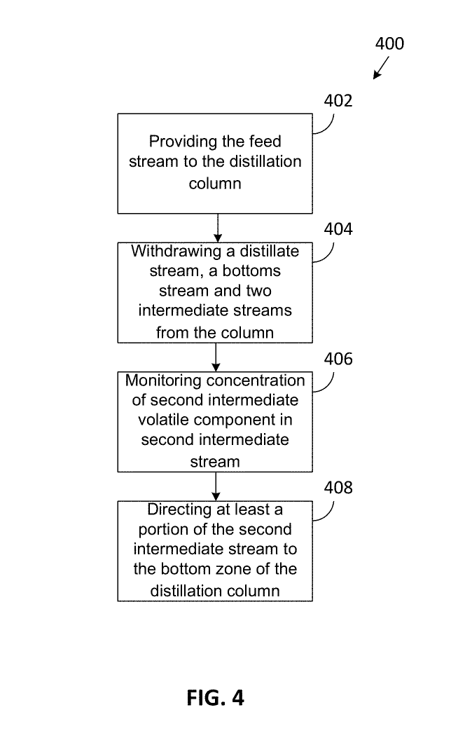

Referring to FIG. 4, a method 400 of separating components of a feed stream in a distillation column is provided. The components including a most volatile component A, a first intermediate volatile component B, a second intermediate volatile component C and a least volatile component D. The distillation column 302 has a top end 342, a bottom end 344, a set of trays 315 and a dividing wall 308 extending between the top end and the bottom end within the distillation column 302.

Step 402 recites providing the feed stream 301 to a pre-fractionation zone 310 of the distillation column 302. In one embodiment, the feed stream can include carbon dioxide as a most volatile component A, dimethyl ether as a first intermediate component B, methanol as a second intermediate component C and water as a least volatile component D.

Step 404 recites withdrawing a distillate stream comprising the most volatile component from a top zone of the distillation column, a bottoms stream comprising the least volatile component from a bottom zone of the distillation column, a first intermediate stream comprising the first intermediate volatile component from an outflow zone of the distillation column and a second intermediate stream comprising the second intermediate volatile component from the outflow zone of the distillation column.

Step 406 recites monitoring a concentration of the second intermediate volatile component in the second intermediate stream withdrawn from the outflow zone of the distillation column.

Step 408 recites directing at least a portion of the second intermediate stream to the bottom zone of the distillation column when a concentration of the second intermediate volatile component in the second intermediate stream falls below a lower bound.

### EXAMPLES

The following non-limiting examples are illustrative of the present application. While the present application has been described with reference to examples, it is to be understood that the scope of the claims should not be limited by the embodiments set forth in the examples, but should be given the broadest interpretation consistent with the description as a whole.

The distillation configuration described herein is a semicontinuous dividing wall column. The proposed method is a combination of semicontinuous single column and continuous divided wall column distillation.

A schematic diagram of the S-DWC process is shown in FIG. 3. The semicontinuous dividing wall column 302 was modelled in Aspen Plus Dynamics.

The dividing wall column 302 has a diameter of three feet, based on the desired total production rate. The dividing wall splits the tray area by a 20:80 ratio between Sections I and II. In order to model the area of each section, an equivalent diameter is calculated for each section of the column. A summary of the model equivalent diameters is below in Table 1. The equivalent diameters are the diameters used to model each section of the column.

TABLE 1
Equivalent model diameters for the different
sections of the dividing wall column.

| | Portion of total area | Area | Equivalent diameter |
|---|---|---|---|
| Section I | 20% | 0.131 m² | 40.89 cm |
| Section II | 80% | 0.525 m² | 81.79 cm |
| Section III | 100% | 0.675 m² | 91.44 cm |
| Section IV | 100% | 0.675 m² | 91.44 cm |

| | | |
|---|---|---|
| Full column area and diameter: | 0.675 m³ | 91.44 cm (3 feet) |

### Control System

One feature of this dividing wall column is its semicontinuous operation. As shown in FIG. 3, the purities of the distillate, bottoms and dimethyl ether side draw can be controlled by manipulating their individual flow rates. The pressure in the condenser drum and the sump level are controlled by the condenser and reboiler duties, respectively. The flow rate to the column is manipulated to control the level of the condenser drum.

The purity of the methanol side draw is controlled by a methanol removal policy. The purity of this stream is set by lower and upper bounds with the average of the two bounds being the desired methanol purity. In this case, the lower bound is 98.7 mol % while the upper bound is 99.2 mol %. Initially, the methanol side steam is recycled. While it is recycled, the purity of methanol in the side stream increases. Once the purity reaches the upper bound, the side draw valve opens and the recycle valve closes, and the high purity methanol is collected from the column. As the methanol is being removed from the column, its purity decreases. Once the purity reaches the lower bound, the side draw valve is closed, the recycle valve opens, and the methanol side draw is recycled again.

### Column Performance

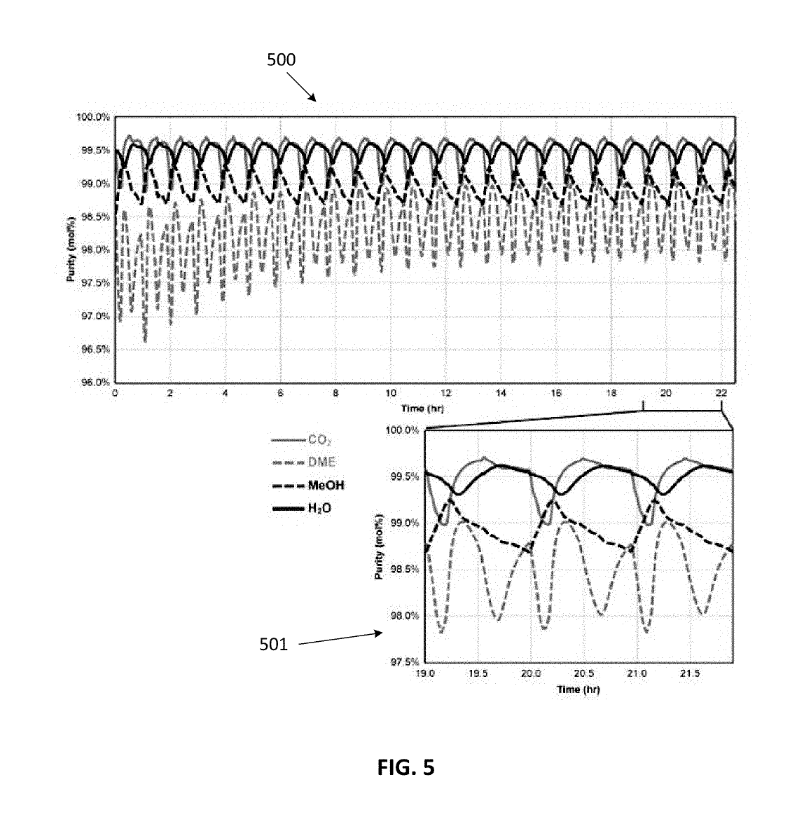

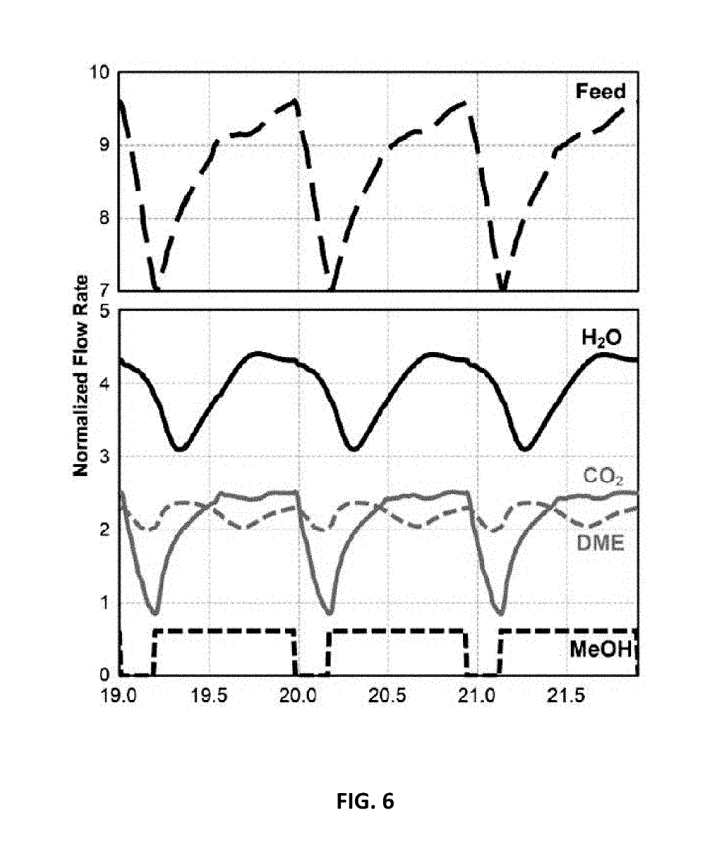

The process is simulated in Aspen Plus Dynamics from an initial state determined by an Aspen Plus steady-state simulation where the methanol side draw valve open and the methanol purity is lower than desired. After the process is simulated for several cycles it approaches a stable limit cycle. The purities of the outlet streams from 24 cycles are shown in FIG. 5. The call-out 501 shows three cycles in more detail and indicates the three cycles that will be shown for all other variables. The flow rates of each of the inlet and outlet streams are shown in FIG. 6; both of these graphs are used to analyze the performance of the column. The average purities and DME flow rate are shown in Table 2.

TABLE 2
The average purities and flow rates of the inlet and outlet streams
of the semicontinuous dividing wall column. The average purities
are calculated using the model data collected every 0.01 hours
and estimated using Simpson's ⅜ rule.

| | CO₂ | DME | Methanol | H₂O |
|---|---|---|---|---|
| Average Purities (mol %) | 99.53% | 98.50% | 98.93% | 99.51% |
| Flow rate (kmol/hr) | | 21.99 | | |

From FIG. 5, graph 500 shows that the distillate and bottoms purities are bouncing around their set point of 99.5 mol % and their controllers are performing well to maintain the average purity at 99.53 mol %, and 99.51 mol %, respectively, as shown in Table 2. The purities of the two side draws vary from the set point as well, and their flow rates compensate for this action as well. The purity of the DME fluctuates the most, however due to its controller, its average purity ends up being right at the set point of 98.50 mol %. The purity of the methanol side draw rises and falls with the alternating between collecting and recycling modes. It is clearly seen that the change in purity switches direction when the methanol side draw valve either opens or closes at the upper and lower bounds. The resulting average purity of methanol is 98.93 mol %.

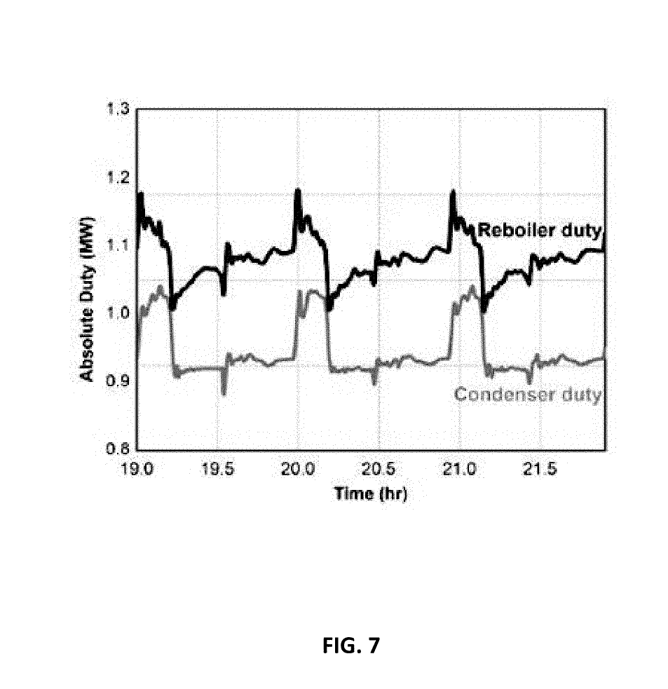

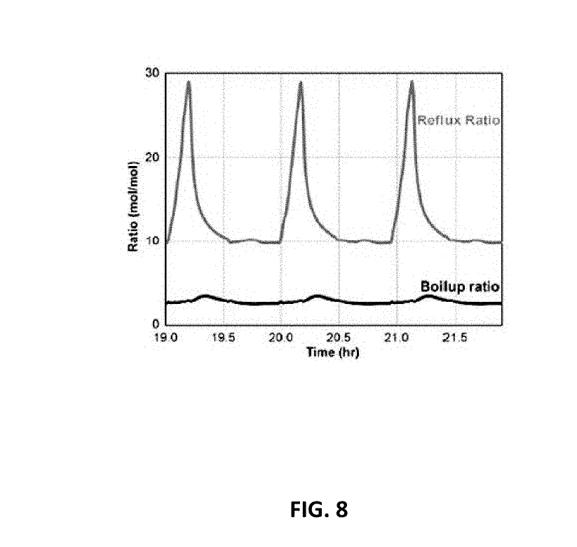

To demonstrate the operability of the column, condenser and reboiler energy usage and reflux and boilup ratios are shown in FIGS. 7 and 8. The average utility usage is summarized in Table 3. The temperatures of the condenser and reboiler are listed in Table 4. The temperatures of the column vary insignificantly compared to the other variables within the column.

TABLE 3
The average duty of the condenser and reboiler.

| Condenser | Reboiler |
|---|---|
| 1.020 MW | 1.128 MW |

TABLE 4
The average and extreme temperatures in
the column (measured in degrees Celsius).

| | Average | Minimum | Maximum |
|---|---|---|---|
| Condenser | −30.6 | −30.9 | −29.7 |
| Reboiler | 192.2 | 191.9 | 192.4 |

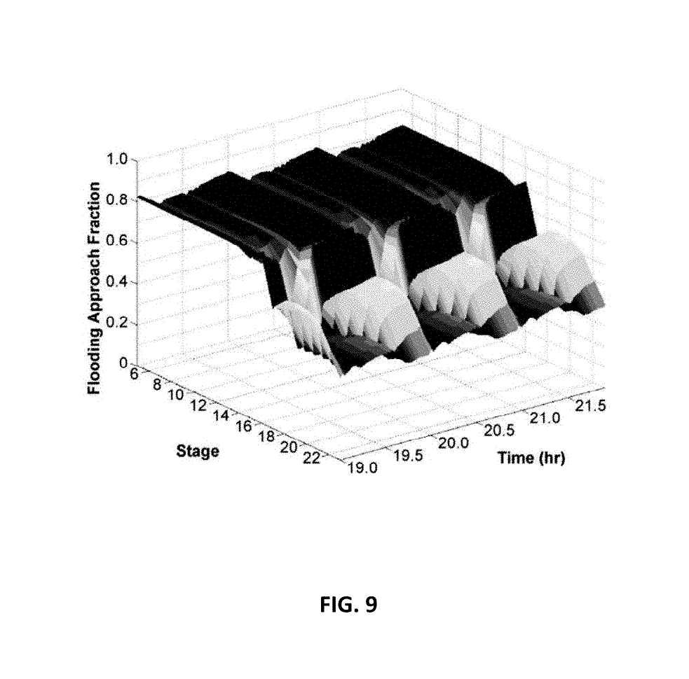

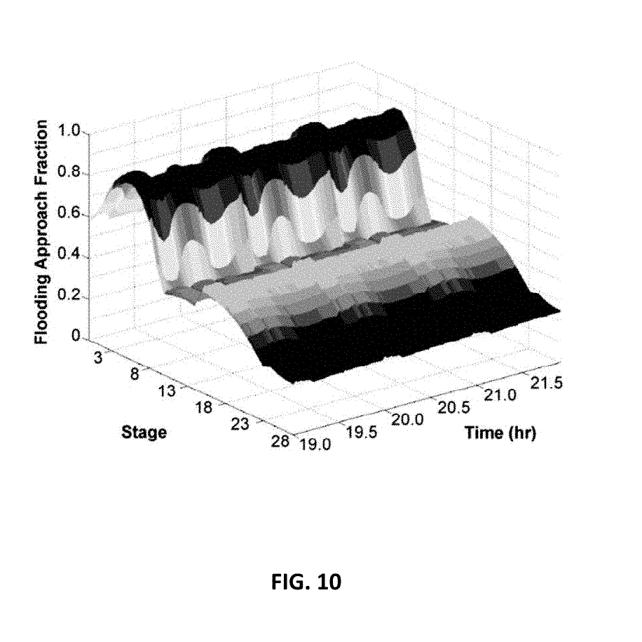

To ensure that column does not violate flooding or weeping constraints, the vapour velocities were tracked throughout each cycle and compared to their bounds. The Fair correlation was used to calculate the flooding velocities. FIGS. 9 and 10 show that the vapour velocities never exceeded 90% of the flooding velocities. Even with the narrow tray spacing in the bottom half of the column, the vapour velocities were low enough to not risk approaching the flooding constraints.

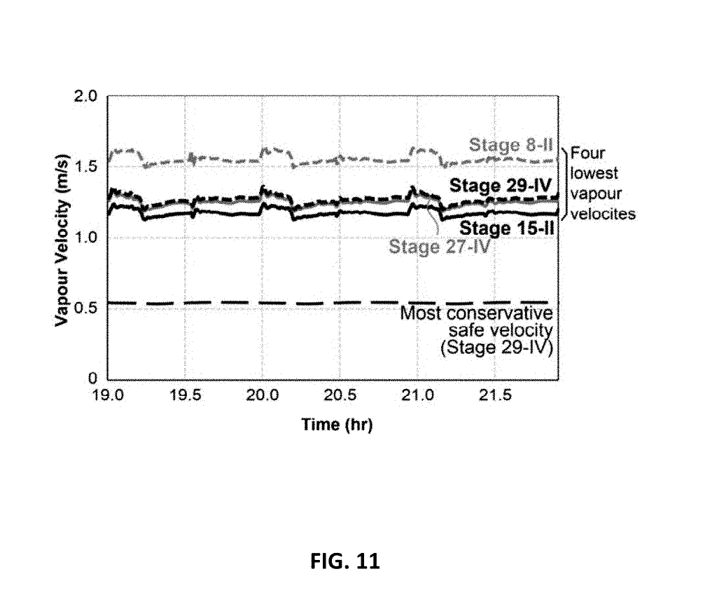

Vapour velocities that are too low, risk causing weeping within the column. A select number of trays were tested for weeping using the Mersmann method. The trays that are tested for weeping are the top and bottom trays along with all the trays that have either inlet or side draw streams. The four slowest vapour velocities are shown in FIG. 11. The highest weeping velocity is also shown, proving there is a low risk of weeping.

Overall, the semicontinuous dividing wall column performs extremely well meeting all of the specifications. As mentioned previously, the methanol stream can be recycled to the reactor in order to help the reaction conversion. Due to the successful modelling of this process, it is now possible to produce DME with a separation unit that fits inside of a shipping container.

While the above description provides examples of one or more apparatus, methods, or systems, it will be appreciated that other apparatus, methods, or systems may be within the scope of the claims as interpreted by one of skill in the art.

What is claimed is:

1. A distillation column for separating components of a feed stream, the feed stream comprising a most volatile component, a first intermediate volatile component, a second intermediate volatile component and a least volatile component, the distillation column comprising:
a top end;
a bottom end spaced from the top end;
a set of trays dispersed along a length of the distillation column between the top end and the bottom end; and
a dividing wall extending between the top end and the bottom end to divide the distillation column into a pre-fractionation zone, a top zone, a bottom zone and an outflow zone;
wherein
the feed stream flows into the pre-fractionation zone, a distillate product stream comprising the most volatile component flows out of the top zone, a bottoms product stream comprising the least volatile component flows out of the bottom zone, and a first intermediate stream comprising the first intermediate volatile component and a second intermediate stream comprising the second intermediate volatile component flow out of the outlet zone; and
at least a portion of the second intermediate stream flows into the distillation column as a recycle when a concentration of the second intermediate volatile component in the second intermediate stream falls below a lower bound.

2. The distillation column of claim 1, wherein the set of trays has 28 trays and the dividing wall divides 20 of the trays.

3. The distillation column of claim 2, wherein the dividing wall divides 20 middle trays of the column.

4. The distillation column of claim 3, wherein the dividing wall divides each of the 20 middle trays so that the pre-fractionation zone occupies 20% of a surface area of each of the 20 middle trays.

5. The distillation column of claim 2, wherein a top 15 trays of the set of trays are spaced 18 inches apart from each other and a bottom 13 trays of the set of trays are spaced 12 inches apart from each other.

6. The distillation column of claim 1, wherein the dividing wall has a top edge and a bottom edge and the pre-fractionation zone extends between the top edge and the bottom edge of the dividing wall.

7. The distillation column of claim 1, wherein the most volatile component is carbon dioxide, the least volatile component is water, the first intermediate volatile component is dimethyl ether and the second intermediate volatile component is methanol.

8. The distillation column of claim 1, wherein the first intermediate stream flows out of tray 8 of the distillation column.

9. The distillation column of claim 1, wherein the second intermediate stream flows out of tray 14 of the distillation column.

10. The distillation column of claim 1, wherein the at least a portion of the second intermediate stream is recycled into tray 26 of the distillation column.

11. A method of separating components of a feed stream in a distillation column, the components including a most volatile component, a first intermediate volatile component, a second intermediate volatile component and a least volatile component, the distillation column having a top end, a bottom end, a set of trays and a dividing wall extending between the top end and the bottom end within the distillation column, the method comprising:
providing the feed stream to a pre-fractionation zone of the distillation column;
withdrawing a distillate stream comprising the most volatile component from a top zone of the distillation column;
withdrawing a bottoms stream comprising the least volatile component from a bottom zone of the distillation column;
withdrawing a first intermediate stream comprising the first intermediate volatile component and a second intermediate stream comprising the second intermediate volatile component from an outflow zone of the distillation column;
monitoring a concentration of the second intermediate volatile component in the second intermediate stream withdrawn from the outflow zone of the distillation column; and
directing at least a portion of the second intermediate stream to the distillation column when a concentration of the second intermediate volatile component in the second intermediate stream falls below a lower bound.

12. The method of claim 11, further comprising stopping the directing of at least a portion of the second intermediate stream to the bottom zone of the distillation column when the concentration of the second intermediate volatile component in the second intermediate stream reaches an upper bound.

13. The method of claim 11, wherein the most volatile component is carbon dioxide, the least volatile component is water, the first intermediate volatile component is dimethyl ether and the second intermediate volatile component is methanol.

14. The method of claim 13, wherein the distillate stream and the bottoms stream are continuously withdrawn from the distillation column.

15. The method of claim 13, wherein the withdrawing of the dimethyl ether from the outflow zone of the distillation column is from tray 8 of the distillation column.

16. The method of claim 13, wherein the withdrawing of the methanol from the outflow zone of the distillation column is from tray 14 of the distillation column.

17. The method of claim 13, wherein the directing at least a portion of the second intermediate stream to the distillation column is into tray 26 of the distillation column.

18. The method of claim 11, wherein the feed stream is continuously provided to tray 17 of the distillation column.

19. The method of claim 11, wherein the lower bound is about 98.7 mol %.

20. The method of claim 11, wherein the upper bound is about 99.2 mol %.
